(19) United States
(12) Patent Application Publication
(10) Pub. No.: US 2004/0062577 A1
(43) Pub. Date: Apr. 1, 2004

(54) Image forming apparatus and transfer unit

(76) Inventors: Kohichi Yamauchi, Yamatokooriyama-shi (JP); Masashi Hirai, Osaka (JP); Fumio Shimazu, Nara-shi (JP); Hiroshi Tachiki, Yamatokooriyama-shi (JP)

Correspondence Address: BIRCH STEWART KOLASCH & BIRCH, PO BOX 747, FALLS CHURCH, VA, 22040-0747, US

(21) Appl. No.: 10/665,529

(22) Filed: Sep. 22, 2003

(30) Foreign Application Priority Data
Sep. 20, 2002 (JP) 2002-276321

(51) Int. Cl. G03G 15/16

(52) U.S. Cl. 399/313

(57) ABSTRACT

A transfer unit 5, which has transfer members 51a corresponding to a plurality of image carriers arranged in a sheet transporting direction, for transferring images carried on the image carriers, has rotary fulcrums 50 in the vicinity of an extension of the axis of a transfer member 51a on an upstream side end portion or on an downstream side end portion in the sheet transporting direction so as to be approximately parallel to the axis, and can be rotated on the rotary fulcrums 50 in directions of moving to and from the image carriers. With this image forming apparatus, it is possible to keep stable orientation of the transfer unit while the apparatus is in operation, thereby realizing stable contact/separation movement of the transfer unit.

### BACKGROUND OF THE INVENTION

1. Field of the Invention

The present invention relates to an image forming apparatus, such as a copying machine, a facsimile machine or a printer, capable of forming a multicolor image, and to a transfer unit capable of transferring a multicolor image.

2. Description of Related Art

Multicolor image forming apparatuses in common use in recent years aiming to speed up image output are of tandem type, provided with four image formation areas having four image carriers, on which electrostatic latent images corresponding to images of different colors (e.g., C: cyan, M: magenta, Y: yellow and K: black) are formed, arranged in parallel, in a sheet transporting direction. A multicolor image can be formed on a sheet by passing the sheet through such a multicolor image forming apparatus of tandem type only once.

This multicolor image forming apparatus can form a monochrome image, more particularly a black and white image using only black developer, as well as a multicolor image. Practically, regarding a multicolor image forming apparatus capable of forming both of a multicolor image and a black and white image, the amount of black and white image formation tends to be larger than the amount of multicolor image formation.

Since black and white image formation in a multicolor image forming apparatus of tandem type does not need all of the four image formation areas, unused image carriers are kept from rotation for the sake of preventing deterioration of unused image formation areas, more particularly of unused image carriers. This prolongs the life of image carriers and reduces running cost.

In a multicolor image forming apparatus of tandem type, when rotation of image carriers which are not used for black and white image formation is stopped, it is necessary to put a sheet transported to the respective image formation areas out of contact with image carriers kept from rotation so as to prevent the image carriers kept from rotation from distorting the black image. For this purpose, image carriers kept from rotation or the transfer unit is moved so as to put the image carriers kept from rotation out of contact with a sheet.

For putting the image carriers out of contact with a sheet, it is common to move the whole transfer unit up and down or to form a rotary fulcrum at the transfer unit and rotate the transfer unit on this rotary fulcrum so as to move the transfer unit away from the image carriers.

Japanese Patent Application Laid-Open H9-292753 (1997) discloses a conventional image forming apparatus constructed to rotate a transfer unit on a rotary fulcrum. This image forming apparatus comprises: transfer members corresponding to a plurality of image carriers arranged apart from each other in a sheet transporting direction; a supporter for supporting both ends of the respective transfer members; and a belt, which is formed not to have an edge, suspended between the ends of the supporter in the sheet transporting direction. The axis of a transfer member which is positioned at a downstream side end portion of the transfer member in the sheet transporting direction forms a rotary fulcrum, and the transfer member rotates on this rotary fulcrum between a separate position, in which the transfer member is separated from image carriers, and a contact position.

Regarding a transfer unit having transfer members corresponding to a plurality of image carriers, it is necessary to apply transfer bias voltage to the respective transfer members to transfer images carried on the image carriers onto a sheet transported on the transfer unit. Consequently, the transfer unit is constructed to reliably keep the respective transfer members insulated from the supporter so as to prevent a trouble of a voltage fall caused by an electric discharge to the other members or a short circuit while applying high transfer bias voltage. Moreover, for applying transfer bias voltage to a transfer nip at an image formation area uniformly, a transfer member having elastic surface is used so as to make the transfer member movable to and from an image carrier and to apply uniform pressure. Consequently, the axis of a transfer member moves up and down slightly as an image carrier rotates between the separate position and the contact position. Moreover, during a transfer operation when a sheet is transported to a transfer nip between each image carrier and each transfer member, a transfer member can be moved away from the image carrier in accordance with the thickness of the sheet.

In the image forming apparatus described in the Japanese Patent Application Laid-Open H9-292753, however, the support state of the transfer unit and the orientation of the transfer unit possibly vary when the transfer unit rotates on the rotary fulcrum formed of a transfer member which has elastic surface as mentioned above and is constructed movable to and from an image carrier. This causes problems that transportation of a sheet or transfer performance changes. Moreover, regarding a transfer unit including a belt, the belt is suspended from a transfer member which forms the rotary fulcrum. When this transfer member is connected to a power source for driving the belt, operations for detaching the transfer unit for mending or the like become difficult since a driving unit, a power transmitting unit and the like are arranged at an end portion of the transfer member.

### BRIEF SUMMARY OF THE INVENTION

The present invention has been made with the aim of solving the above problems, and it is a principal object thereof to provide an image forming apparatus capable of keeping stable orientation of a transfer unit while the image forming apparatus is in operation and capable of realizing stable contact/separation movement of the transfer unit.

Another object of the present invention is to provide an image forming apparatus capable of transferring images carried on the respective image carriers precisely even when a change in the position of a transfer member with respect to an image carrier is caused by rotation of the image carrier, change in the type of a sheet used or the like.

Another object of the present invention is to provide an image forming apparatus capable of realizing high accuracy in the positional relation between the rotary fulcrum and transfer members in either image transfer mode.

Another object of the present invention is to provide an image forming apparatus capable of switching rapidly between a monochrome image transfer mode, in which one transfer member closer to the center of rotary movement is used for transfer, and a multicolor image transfer mode, in which all the transfer members are used for transfer, and thereby capable of realizing high image transfer efficiency.

Still another object of the present invention is to provide a transfer unit in which all the transfer members have elasticity so as to be movable to and from the respective image carriers.

An image forming apparatus according to the present invention comprises: a plurality of image carriers arranged in a sheet transporting direction; and a transfer unit, which has transfer members corresponding to the respective image carriers, for transferring images carried on the respective image carriers. The transfer unit of this image forming apparatus has a rotary fulcrum in the vicinity of an extension of the axis of a transfer member located on the upstream side end portion or on the downstream side end portion in the sheet transporting direction so as to be approximately parallel to the axis, and can be rotated on the rotary fulcrum in directions of moving to and from the image carriers.

With this invention, the rotary fulcrum which supports the transfer unit does not change even when a change in the position of a transfer member with respect to an image carrier is caused by rotation of the image carrier, change in the type of a sheet used or the like. It is therefore possible to keep stable orientation of the transfer unit especially while the image forming apparatus is in operation, thereby realizing preferable image formation. It is also possible to achieve stable contact/separation movement of the transfer unit.

Moreover, since a rotary fulcrum is provided separately from any shaft of transfer members, all the transfer members can be made elastic so as to be movable in directions of moving to and from the image carriers. Consequently, when the transfer unit is constituted of an endless belt suspended from a supporter for supporting a plurality of transfer members and the supporter is composed of two supporting members which are respectively located on upstream side and downstream side in the sheet transporting direction and connected with each other, a mechanism having the same components can be employed as a mechanism for supporting transfer members of the respective supporting members.

Moreover, the transfer members of the image forming apparatus according to the present invention may be movable in directions of moving to and from the image carriers.

With this invention, it is possible to move the transfer members to and from the image carriers even when a change in the position of a transfer member with respect to an image carrier is caused by rotation of image carriers, change in the type of a sheet used or the like. Since transfer is performed with a constant pressure applied on the image carriers, images carried on the respective image carriers can be transferred onto a sheet precisely.

Moreover, the transfer unit of the image forming apparatus according to the present invention may have a supporter for supporting the transfer members, and the supporter may have the rotary fulcrum.

With this invention, it is possible to realize high accuracy in the positional relation between the rotary fulcrum and the transfer members. It is also possible to rotate the whole transfer unit on the rotary fulcrum and to achieve contact/separation movement without changing the orientation of the transfer unit. Since the suspension state of the transfer unit differs little between a case where the transfer unit is in a separate position and a case where the transfer unit is in a contact position, it is possible to form a preferable image both in a multicolor image transfer mode and in a monochrome image transfer mode.

Furthermore, the transfer unit of the image forming apparatus according to the present invention may be rotatable on the rotary fulcrum so that the distance between a transfer member adjacent to the transfer member closer to the rotary fulcrum and an image carrier corresponding to the transfer member comes to between 2.5 mm and 4 mm when the members are separated.

With this invention, since the above-mentioned distance between the separated members is set between 2.5 mm and 4 mm, the total height of the image forming apparatus can be reduced and the time required for completing separation of the transfer unit can be comparatively short. Consequently, it is possible to switch rapidly between a monochrome image transfer mode, in which one transfer member closer to the rotary fulcrum is used for transfer, and a multicolor image transfer mode, in which all the transfer members are used for transfer, and it is therefore possible to realize high image transfer efficiency.

A transfer unit according to the present invention comprises a plurality of juxtaposed transfer members and a supporter for supporting the transfer members so as to be rotatable and movable in a radial direction. The supporter of this transfer unit has a rotary fulcrum in the vicinity of an extension of the axis of a transfer member located at one end portion in a direction in which the transfer members are juxtaposed, so as to be approximately parallel to the axis.

With this invention, since a rotary fulcrum is provided separately from any transfer member, all the transfer members can be made elastic so as to be movable in directions of moving to and from the image carriers. Consequently, when the transfer unit is constituted of an endless belt suspended from a supporter for supporting a plurality of transfer members and the supporter is composed of two supporting members which are respectively located on upstream side and downstream side in the sheet transporting direction and connected with each other, a mechanism having the same components can be employed as a mechanism for supporting transfer members of the respective supporting members. Moreover, since a rotary fulcrum may be formed at one supporting member which does not require the rotary fulcrum, both of the supporting members may be formed in the same shape.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic view illustrating the structure of an image forming apparatus according to the present invention;

FIG. 2 is a perspective view illustrating the structure of a transfer unit according to the present invention;

FIG. 3 is a perspective view of the transfer unit of an image forming apparatus according to the present invention wherein some parts of a belt and the like are omitted;

FIG. 4 is a perspective view illustrating the structure of a supporter of a transfer unit in an image forming apparatus according to the present invention;

FIG. 5A is a perspective view wherein the upstream side part of a rotary fulcrum of a transfer unit is enlarged;

FIG. 5B is a perspective view wherein the downstream side part of the rotary fulcrum of the transfer unit is enlarged;

FIG. 6 is a schematic view illustrating a condition where a transfer unit of an image forming apparatus according to the present invention is rotated into a contact position;

FIG. 7 is a schematic view illustrating a condition where the transfer unit of the image forming apparatus according to the present invention is rotated into a separate position;

FIG. 8 is a perspective view illustrating the structure of contact/separation means of an image forming apparatus according to the present invention;

FIG. 9 is a schematic view illustrating the structure of a transfer unit and contact/separation means of an image forming apparatus according to the present invention; and

FIG. 10 is a schematic view illustrating the structure of an image forming apparatus of indirect transfer type.

### DETAILED DESCRIPTION OF THE INVENTION

The following description will explain the present invention in detail with reference to the drawings illustrating an embodiment thereof.

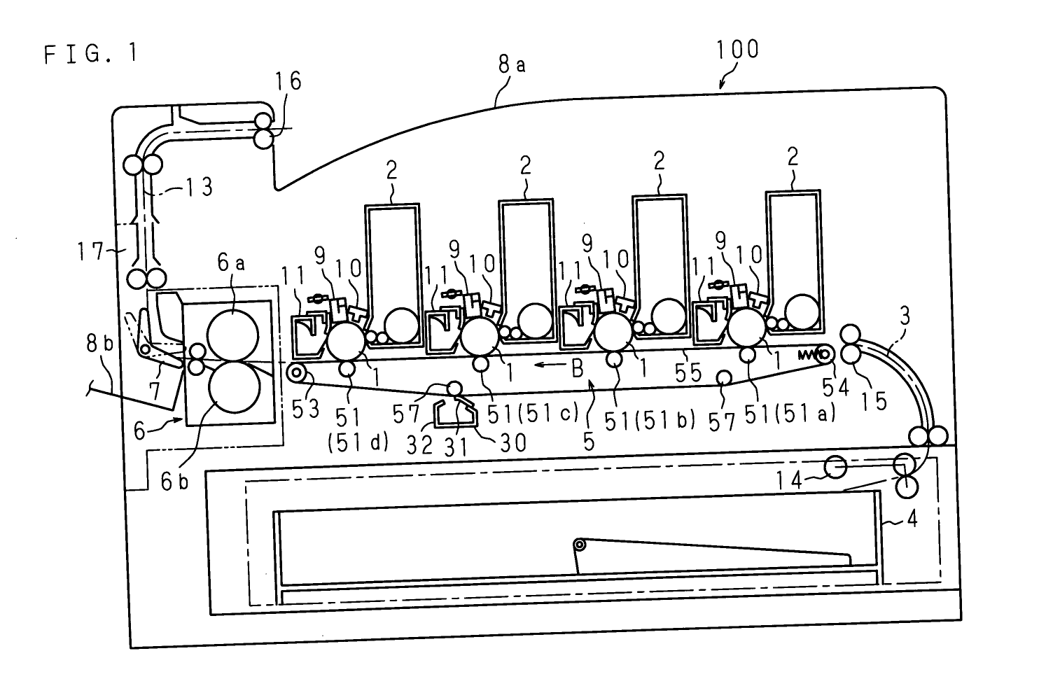

FIG. 1 is a schematic view illustrating the structure of an image forming apparatus according to the present invention. The image forming apparatus in FIG. 1 is designed to form a multicolor image and a monochrome image on sheets (recording paper sheets) in accordance with image data transmitted from the outside.

As shown in FIG. 1, this image forming apparatus comprises: a plurality of rotatable image carriers 1 constituted of photoconductor drums, which are arranged apart from each other in a sheet transporting direction, for carrying electrostatic latent images on the surface thereof; a developing unit 2 for developing the electrostatic latent images carried on the image carriers 1; a sheet supplier 4 for supplying a sheet through a sheet transport path 3 toward the image carriers 1; a transfer unit 5 for transferring images carried on the respective image carriers 1 onto a sheet; a fixing unit 6 for applying heat fusing to images transferred onto the sheet; and sheet discharge sections 8a and 8b for discharging the sheet, to which the images are fixed, through a switching gate 7.

Arranged around each image carrier 1 are: a charging unit 9 for electrically charging the surface of the image carrier 1 uniformly; a light exposure unit 10 for forming an electrostatic latent image according to the image data on the surface of the image carrier 1; the above-mentioned developing unit 2; and a cleaner unit 11 for removing developer remaining on the image carrier 1 to allow the next electrostatic developing.

The image data handled by the image forming apparatus corresponds to a color image of colors of black (K), cyan (C), magenta (M) and yellow (Y). Consequently, four sets of image carriers 1, developing units 2, charging units 9, light exposure units 10 and cleaner units 11, each set corresponding to each color, are provided to form four types of latent images. The four image formation areas correspond to black, cyan, magenta and yellow in this order from the upstream side of the sheet transporting direction.

The image carriers 1 are arranged in an approximately center portion of the body of the image forming apparatus 100.

Each charging unit 9 is charging means for electrically charging the surface of each image carrier 1 uniformly to be in a predetermined potential. A contact roller-type charging unit, a brush-type charging unit, or a charger-type charging unit illustrated in FIG. 1 may be employed. Used as the light exposure unit 10 is a laser scanning unit (LSU) including a writing head of, for example, EL or LED having arrayed luminous elements, a laser irradiating unit and a reflecting mirror. By exposing electrically charged image carriers 1 to light in accordance with inputted image data, electrostatic latent images according to the image data are formed on the surface of the image carriers 1. The developing units 2 make the electrostatic latent images formed on the surface of the image carriers 1 visible by toner of colors K, C, M and Y. The cleaner units 11 remove and recover toner remaining on the surface of the image carriers 1 after developing and transferring of images.

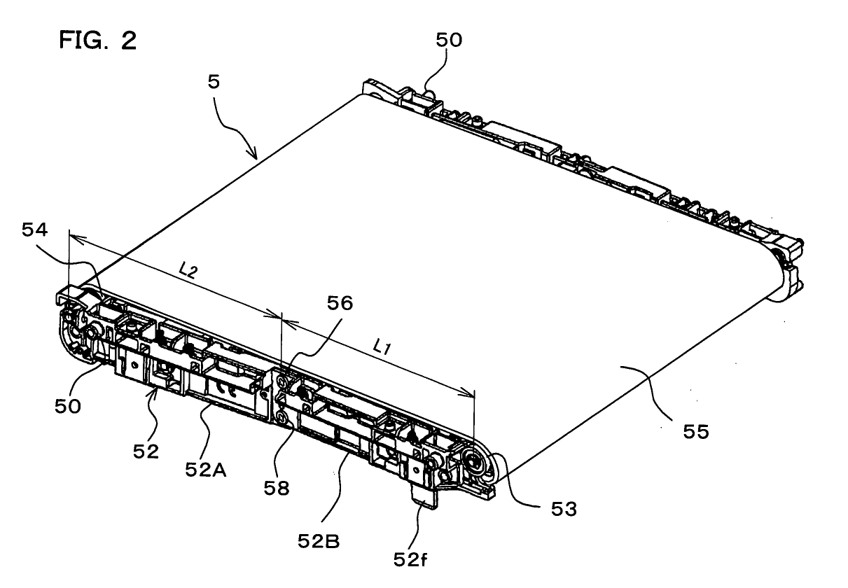

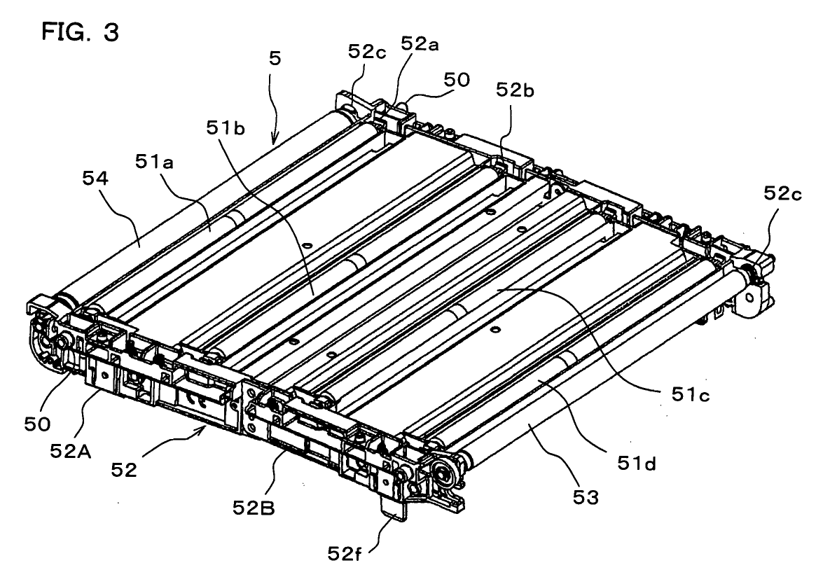

FIG. 2 is a perspective view illustrating the structure of a transfer unit, and FIG. 3 is a perspective view of the transfer unit wherein some parts of a belt and the like are omitted.

The transfer unit 5 arranged below the image carriers 1 comprises: four transfer members (transfer rollers) 51 (51a, 51b, 51c, 51d) juxtaposed apart from each other so as to correspond to the respective image carriers 1; a supporter 52 for supporting both end portions of the transfer members (transfer rollers) 51 so as to be rotatable and movable in a radial direction; a driving roller 53 which is rotatably supported on a downstream side end portion in the sheet transporting direction of the supporter 52; a tension roller 54 which is rotatably supported on an upstream side end portion in the sheet transporting direction of the supporter 52; and an endless belt 55 suspended between the driving roller 53 and the tension roller 54. The belt 55 is driven to rotate in a direction indicated by an arrow B in FIG. 1.

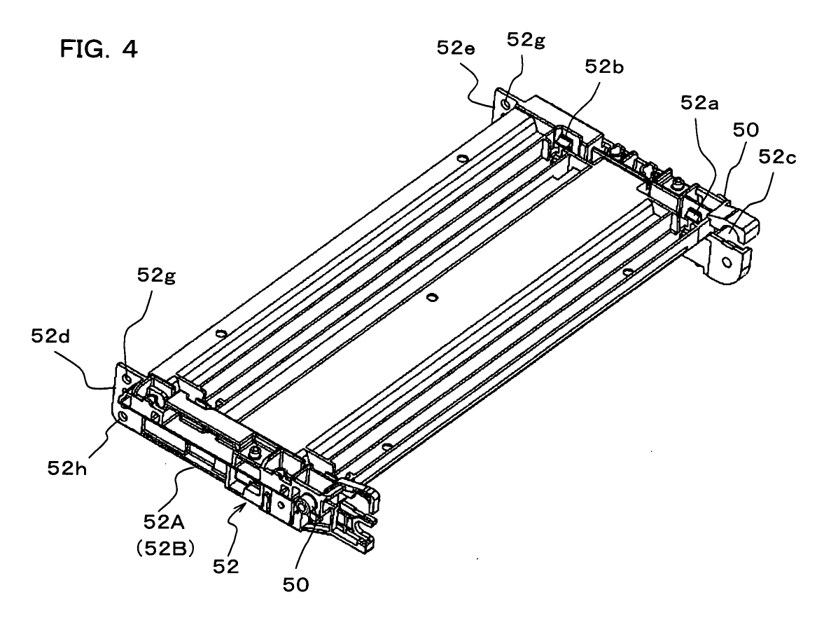

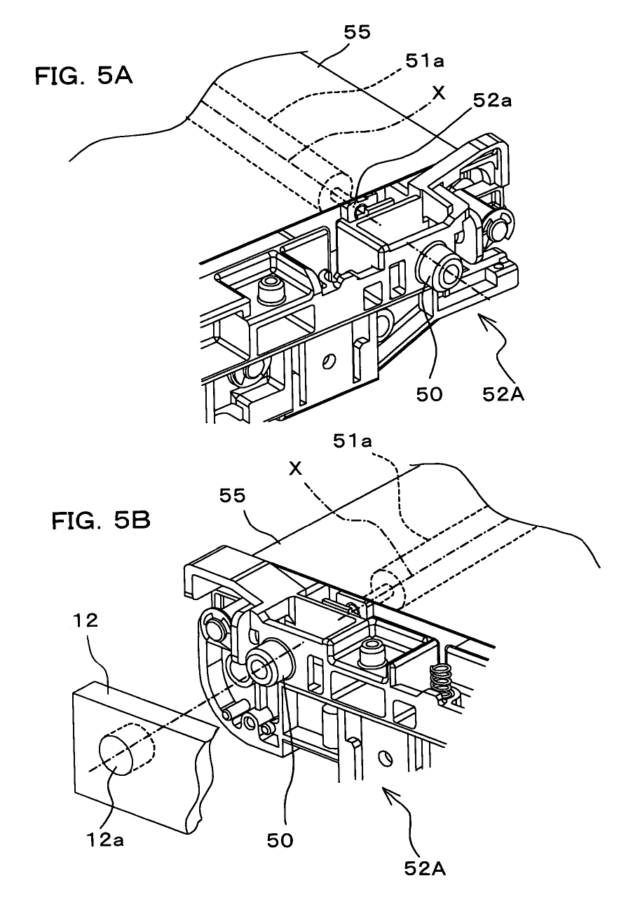

FIG. 4 is a perspective view illustrating the structure of a supporter of a transfer unit, FIG. 5A is a perspective view wherein the upstream side part of a rotary fulcrum of the transfer unit is enlarged, and FIG. 5B is a perspective view wherein the downstream side part of the rotary fulcrum of the transfer unit is enlarged.

The supporter 52 is formed by connecting a first supporting member 52A, which supports two transfer members (transfer rollers) 51a, 51b and the tension roller 54, and a second supporting member 52B, which supports two transfer members (transfer rollers) 51c, 51d and the driving roller 53, with two connecting members 56 constituted of stepped screws so as to be relatively rotatable. The stepped screws used as the connecting members 56 function as axes and can be tightened. By tightening one of the stepped screws on the first supporting member 52A or the second supporting member 52B, the first supporting member 52A and the second supporting member 52B can be connected with each other so as to be relatively rotatable on the stepped screw. The first supporting member 52A and the second supporting member 52B are formed in the same shape, and are connected with each other by the connecting members 56 in a manner that one of the supporting members is rotated 180° from the other. Provided in the middle of the first supporting member 52A and the second supporting member 52B in a sheet transporting direction are a first shaft supporting portion 52a and a second shaft supporting portion 52b. Provided on the upstream side of the first and second supporting members 52A and 52B in a sheet transporting direction are third shaft supporting portions 52c. Provided on the downstream side of the first and second supporting members 52A and 52B in a sheet transporting direction are a first connecting portion 52d and a second connecting portion 52e. Furthermore, rotary fulcrums 50 are projected from the first supporting member 52A and the second supporting member 52B in a direction directing away from the proximity of the first shaft supporting portion 52a.

These rotary fulcrums 50 are constituted of shafts which are formed integrally with the first supporting member 52A and the second supporting member 52B, and are formed on an extension of the axis X of a transfer member (transfer roller) 51a supported on the first shaft supporting portion 52a so as to be approximately parallel to the axis X. Moreover, contact tongues 52f are projected from the lower faces of the first supporting member 52A and the second supporting member 52B on the side of third shaft supporting portions 52c. Furthermore, fourth shaft supporting portions (not illustrated in figures) are provided.

The rotary fulcrums 50 of the first supporting member 52A are rotatably engaged with support holes 12a formed at frame members 12 provided on both sides of the body of the image forming apparatus 100, so that the transfer unit 5 can be rotated between a separate position, in which the transfer unit 5 is separated from the image carriers 1, and a contact position. Though the rotary fulcrums 50 of the second supporting member 52B are not used in the present embodiment, they may be used. Moreover, the rotary fulcrums 50 of the second supporting member 52B may be used in other ways (for positioning and setting the height of the transfer unit 5, for guiding in attaching and removing the transfer unit or the like).

Two transfer members (transfer rollers) 51a and 51b are supported on the first and second shaft supporting portions 52a and 52b of the first supporting member 52A so as to be rotatable and movable in a radial direction. The tension roller 54 is rotatably supported on the third shaft supporting portion 52c. Two transfer members (transfer rollers) 51c and 51d are supported on the first and second shaft supporting portions 52a and 52b of the second supporting member 52B so as to be rotatable and movable in a radial direction. The driving roller 53 is rotatably supported on the third shaft supporting portion 52c. Furthermore, driven rollers 57 are rotatably supported on the fourth shaft supporting portions of the first supporting member 52A and the second supporting member 52B (see FIG. 1). Connection bores 52g and rotation regulating bores 52h are provided at the first and second connection portions 52d and 52e. Note that the connection bores 52g and the rotation regulating bores 52h of the second connection portion 52e are formed as through bores.

The first connecting portion 52d of the first supporting member 52A faces and contacts with the second connection portion 52e of the second supporting member 52B, and the second connection portion 52e of the first supporting member 52A faces and contacts with the first connection portion 52d of the second supporting member 52B. With this arrangement, the first supporting member 52A and the second supporting member 52B are connected with each other so as to be relatively rotatable, by tightening the connecting members 56 constituted of stepped screws on the connection bores 52g of the first and second connecting portions 52d and 52e. Moreover, the relative rotation between the first supporting member 52A and the second supporting member 52B is prevented by tightening regulation members 58 constituted of stepped screws on the rotation regulating bores 52h of the first and second connecting portions 52d and 52e. The same stepped screws are used as the connecting members 56 and the regulation members 58. Positioning and fixing of the first supporting member 52A and the second supporting member 52B are performed by tightening the connecting members 56 and the regulation members 58 on a reinforcing plate having tapped holes, which is not illustrated in figures.

The length in the sheet transporting direction of the first supporting member 52A and the second supporting member 52B are L1 and L2 which extends from the center of the connection bores 52g to the center of the driving roller 53 and the tension roller 54. L1 is approximately equal to L2. When the first supporting member 52A and the second supporting member 52B relatively rotate on connecting members 56 in a condition where the connecting members 56 are attached (the regulation members 58 are not attached), in other words, when the transfer unit 5 is bend, the unit forms an approximately equilateral triangle and replacement of the belt 55 can be therefore performed extremely easily.

The transfer unit 5 can be bent smoothly by detaching the regulation members 58 and loosening the connection members 56. For making the unit 5 function as a transfer unit, the relative rotation between the first supporting member 52A and the second supporting member 52B are prevented by driving the connecting members 56 in and attaching the regulation member 58, so that the first supporting member 52A and the second supporting member 52B can be fixedly connected. Consequently, it is possible to provide better service in replacement of the belt 55 and to maintain preferable image quality in operation.

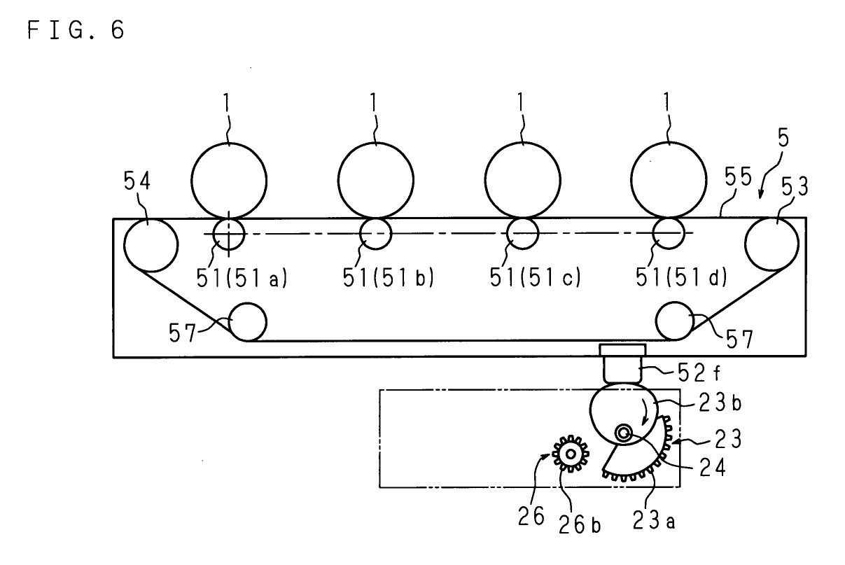

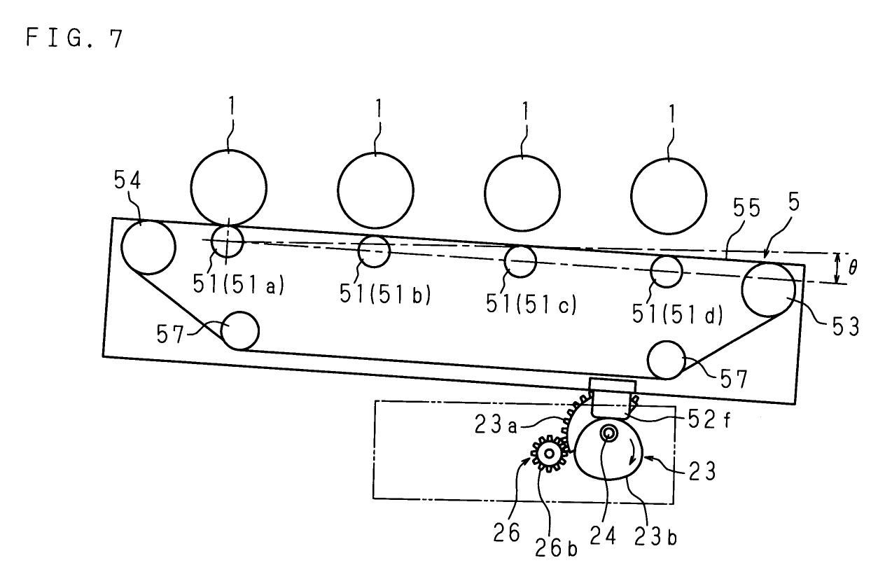

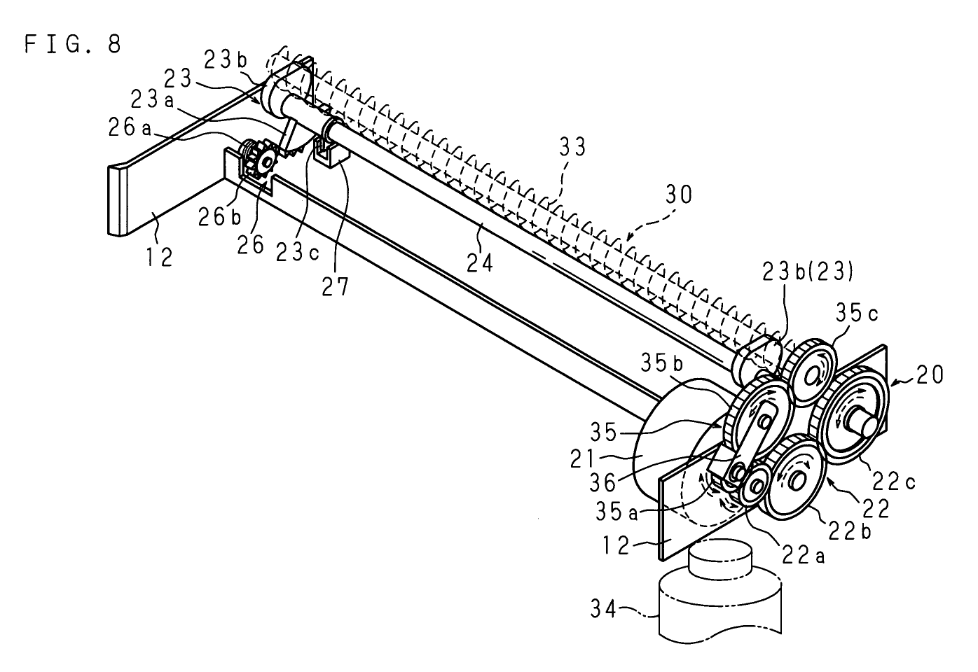

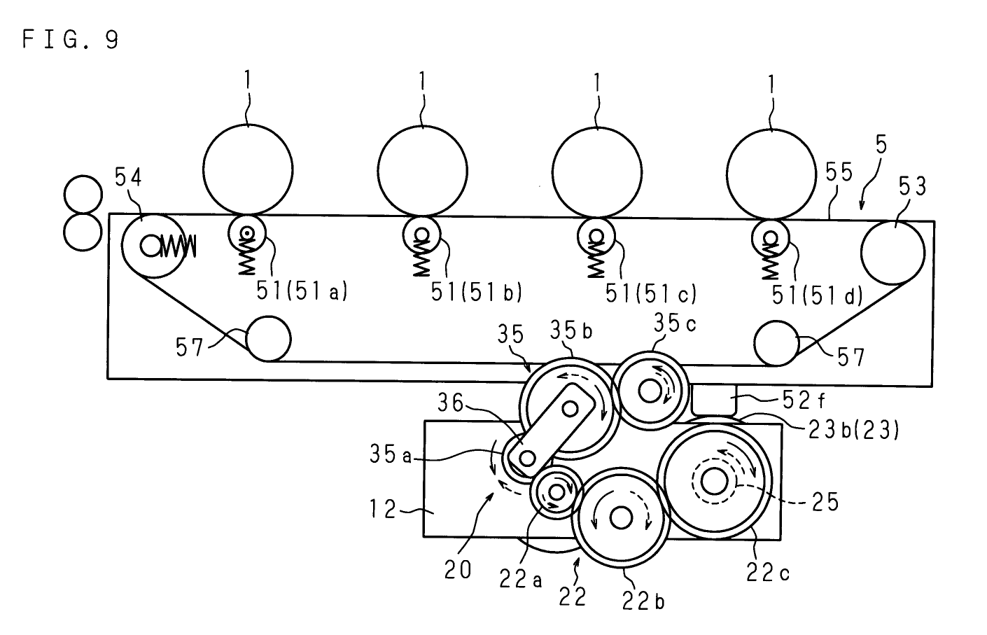

FIG. 6 is a schematic view illustrating a condition where the transfer unit is rotated into a contact position, FIG. 7 is a schematic view illustrating a condition where the transfer unit is rotated into a separate position, FIG. 8 is a perspective view illustrating the structure of contact/separation means, and FIG. 9 is a schematic view illustrating the structure of the transfer unit and contact/separation means.

Rotational angle θ (see FIG. 7) of the transfer unit 5 on the rotary fulcrums 50 is set to obtain a separation of 2.5˜4 mm between a transfer member (transfer roller) 51b adjacent to a transfer member (transfer roller) 51a having an axis which approximately accords with the axis of the rotary fulcrums 50 and a corresponding image carrier 1, as shown in Table 1. The rotational angle θ is set between 2° and 3° in the example. Table 1 shows data gathered from an experiment made for deciding the separation between 2.5 mm and 4 mm, and a result of the experiment made using a separation as a parameter with respect to rubbing between a photoconductor drum 51 corresponding to the transfer member 51b and an end portion of a sheet and poor transfer (retransfer).

The rotational angle θ and the separation are not limited to the above-mentioned values, and the separation may be smaller or larger (the rotational angle may be smaller or larger) as long as the transfer member (transfer roller) 51b adjacent to the transfer member (transfer roller) 51a having an axis which approximately accords with the axis of the rotary fulcrums 50 and an image carrier 1 corresponding to the transfer member (transfer roller) 51b do not distort an image transferred onto a sheet. It is, however, preferable to set the angle (the separation) as small as possible for the following reasons: in a case where the height of sheet transporting significantly varies between a multicolor image transfer mode and a monochrome image transfer mode in a transfer unit 5 for transporting a sheet to a belt 55 for transfer, a problem occurs in transporting a sheet to a fixing section while the sheet is moved away from the belt 55 or supplied to the belt 55; the total height of an image forming apparatus depends on the value of the rotational angle θ; and time required for switching between the multicolor image transfer mode and the monochrome image transfer mode also depends on the rotational angle θ. In this embodiment, the rotational angle θ is set to the minimum value of 2.5 mm. Note that a lot of time is required for contact/separation movement of the transfer unit 5 when the separation between the transfer member (transfer roller) 51b and the image carrier 1 corresponding to the transfer member (transfer roller) 51b in the separate position is large. Moreover, in this case, the height of the belt 55 on the most downstream side varies between the monochrome image transfer mode and the multicolor image transfer mode, and a problem occurs in transporting a sheet from the belt 55 to the next fixing unit 6. Furthermore, in this case, wrinkling is generated on a sheet, or an image which is transferred onto a sheet and is not fixed yet is distorted, causing deterioration of image formation quality. Moreover, in a case where the separation between the transfer member (transfer roller) 51b and the image carrier 1 corresponding to the transfer member (transfer roller) 51b in a separate position is too small, an image which is transferred and fixed to a sheet contacts with image carriers 1, which are not used for image formation and prevented from rotation, and rubbing causes deterioration of image quality. Moreover, in this case, poor transfer (especially retransfer) tends to cause deterioration of image density or deterioration of image quality owing to generation of unevenness of image density.

In Table 1, the symbol “G” indicates that the result was always good, the symbol “P” indicates that the result was always poor and the symbol “G/P” indicates that the result was sometimes poor. The environmental conditions in which the experiment result in Table 1 was obtained were high temperature and high humidity (30° C., 85%). Since experiments in other environmental conditions (for example, low temperature and low humidity) gave results more preferable than the result in Table 1, these experiment results are omitted. Note that weight of a standard sheet is 81˜105 g/m².

TABLE 1

| SEPARATION (mm) | | 0.5 | 1 | 1.5 | 2 | 2.5 | 3 | 3.5 | 4 |
|---|---|---|---|---|---|---|---|---|---|
| PHENOM- | SHEET | | | | | | | | |
| ENON | TYPE | | | | | | | | |
| RUBBING | 60˜105 | P | P | G/P | G | G | G | G | G |
| AT BACK | g/m² | P | G/P | G | G | G | G | G | G |
| END OF | 105˜300 | G | G | G | G | G | G | G | G |
| SHEET | g/m² | P | P | P | G/P | G | G | G | G |
| | OHP | | | | | | | | |
| | EN- | | | | | | | | |
| | VELOPE | | | | | | | | |
| POOR | 60˜105 | G/P | G | G | G | G | G | G | G |
| TRANSFER | g/m² | G/P | G | G | G | G | G | G | G |
| (RE- | 105˜300 | G/P | G | G | G | G | G | G | G |
| TRANS- | g/m² | G/P | G | G | G | G | G | G | G |
| FER) | OHP | | | | | | | | |
| | EN- | | | | | | | | |
| | VELOPE | | | | | | | | |

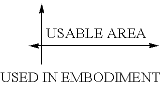

The transfer members (transfer rollers) 51 give transfer bias voltage for transferring toner images on the image carriers 1 onto a sheet adsorbed and transported on the belt 55. The axis X of a transfer member (transfer roller) 51a located at an upstream side end portion in the sheet transporting direction is used as a reference to set the rotary fulcrums 50.

The belt 55 is designed to contact with the respective image carriers 1 by pressure applied by the respective transfer members 51 when the belt 55 is in a contact position of a multicolor mode. A color toner image (multicolor toner image) is formed by transferring toner images of respective colors formed on the respective image carriers 1 onto a sheet so as to be piled in sequence. The belt 55 is formed into a ring-shape by using a film having a thickness of 100 μm.

Toner images are transferred from the image carriers 1 onto a sheet by the transfer members (transfer rollers) 51 in contact with the rear face of the belt 55. High transfer bias voltage (high voltage of a polarity (+) opposite to the polarity (−) of electric charge of toner) for transferring toner images is applied to the transfer members (transfer rollers) 51. Each transfer member (transfer roller) 51 is based on a metal shaft such as stainless steel having a diameter of 8˜10 mm, and the surface thereof is covered with electrically conductive elastic material (such as EPDM or urethane foam). The electrically conductive elastic material makes it possible to apply high voltage to a sheet uniformly.

The transfer unit 5 which is constructed to be rotatable on the fulcrums 50 between a separate position and a contact position is moved by contact/separation means 20 illustrated in FIGS. 8 and 9.

The contact/separation means 20 comprises a power transmission gear mechanism 22 interlocking with a drive source 21 constituted of a motor for driving contact/separation movement, and a pair of cams 23 interlocking with rotation of the power transmission gear mechanism 22.

The power transmission gear mechanism 22 is attached to a frame member 12 provided at one side of the body of the image forming apparatus 100, and comprises: a driving gear 22a fixed at an output shaft of the drive source 21; an intermediate gear 22b engaged with the driving gear 22a; and a driven gear 22c engaged with the intermediate gear 22b.

This driven gear 22c is mounted, via a one-way clutch 25, on a rotary shaft 24 supported on the frame members 12 provided at both sides of the body of the image forming apparatus 100. The pair of cams 23 is provided on both end portions of the rotary shaft 24.

The cam 23 is formed of resin such as self-lubricative polyacetal. As shown in FIGS. 6 and 7, the cam 23 has a partial gear 23a in a sector form, which has a series of gear teeth arranged on only a part of the circumference thereof and a cam portion 23b to be in contact with the contact portion 52f, which are integrally formed. A torque limiter 26 to be engaged with the partial gear 23a is provided on one of the frame members 12. A sensor blade 23c is integrally formed with one of the cams 23 so that the position of the cam 23 is detected by a detector 27 provided at the body of the image forming apparatus 100.

The torque limiter 26 (see FIG. 8) is composed of two washers, such as flat washers made of resin, which can slide preferably; a compression spring 26a and a brake gear 26b interposed between the two washers; and the like. The torque limiter 26 buffers and controls separation movement of the transfer unit 5 and holds the unit in a stable stop state in a separate position.

The load torque applied to the rotary shaft 24 of the partial gear 23a is 63.7 N·cm. The braking force of the torque limiter 26 is set to be 11.7˜15.7 N·cm at the rotary shaft 24 of the partial gear 23a. The braking force is set to a relatively small value to prevent a braking force from acting on the drive source 21. With this setting, rotation of the driven gear 22c in a direction indicated with the arrow of continuous line in FIG. 8 is permitted by the one-way clutch 25, so that the partial gear 23a rotates slightly ahead of the rotation of the drive source 21 by the load applied to the cam portion 23b. Note that a wrapping connector mechanism having a belt, a pulley on which the belt is hung and the like may be employed instead of the power transmission gear mechanism 22.

The load applied to each cam portion 23b of each cam 23 is 49 N, wherein the cam portions 23b of the right and left cams 23 are supporting the load of 98 N in total applied by the transfer unit 5, sharing the burden with each other. Though this embodiment uses a partial gear 23a of a cam 23 having teeth over 150 degrees, the value can be modified in a suitable manner in accordance with design conditions.

With the above structure, the transfer unit 5 which is first in a contact position (multicolor image transfer mode) in contact with all the image carriers 1 as illustrated in FIG. 6 is rotated on the fulcrums 50 into a separate position illustrated in FIG. 7 by regular rotation of the drive source 21 (in a direction of an arrow of continuous line) and rotation of the cam 23 over 180°. The downstream side in the sheet transporting direction of the transfer unit 5 moves away from the image carriers 1 until a monochrome image transfer mode in which only an image carrier 1 positioned in upstream side in the sheet transporting direction is in contact with the belt 55 is realized. For moving the transfer unit 5 away from rotating image carriers 1 to switch the image transfer mode, a separation movement is achieved with the image carriers 1 and the transfer unit 5 being rotated in a constant speed, and the rotation of the image carriers 1 is stopped after rotation of the transfer unit 5 into a separate position is completed and the belt 55 is completely separated from the image carriers 1.

When the transfer unit 5 rotates into a separate position, the partial gear 23a of the cam 23 engages with the brake gear 26b of the torque limiter 26 and a braking force is applied. As a result, the advance rotation of the partial gear 23a is buffered and controlled, the separation movement of the transfer unit 5 is buffered, and the transfer unit 5 can be smoothly guided into a separate position.

The partial gear 23a is not engaged with the brake gear 26b of the torque limiter 26 when the transfer unit 5 is in a contact position and the cam portion 23b is in the highest position, while only one tooth of the partial gear 23a engages with the brake gear 26b of the torque limiter 26 when the transfer unit 5 is in a separate position and the cam portion 23b is in the lowest position. With this engagement, a braking force acts so as to prevent the belt 55 from being drifted improperly in a state where the transfer unit 5 is in a separate position, so that the belt 55 is held in a stable manner.

The apparatus is such constructed that the load of the transfer unit 5 is directed toward the rotational axis of the cam 23 (vertically downward). Consequently, even when the cam portion 23b of the cam 23 is in the highest position, no force that makes the cam 23 to rotate is generated by the load of the transfer unit 5. The transfer unit 5 is therefore held in a stable manner.

Note that, when employing a stepping motor as the drive source 21 for the contact/separation means 20 and as a drive source for driving the image carriers 1 and the driving roller 53 of the transfer unit 5, the control of the speed and position can be performed in an open-loop manner with high accuracy and timing of each operation can be controlled easily and appropriately.

Since toner adhering to the belt 55 owing to contact between the image carriers 1 and the belt 55 may make the rear surface of the sheet dirty, the cleaning unit 30 illustrated in FIGS. 1 and 8 recovers the toner. The cleaning unit 30 comprises: a toner holder 32 (see FIG. 1) having a blade 31 for scraping out toner remaining on the belt 55 by contacting with the belt 55; an auger 33 (see FIG. 8) which is rotatably supported in the toner holder 32; a toner recovery container 34 for collecting toner transferred by the auger 33; and an interlocking mechanism 35 for interlocking the auger 33 with the drive source 21. The interlocking mechanism 35 includes a power transmission gear 35a engaged with the driving gear 22a of the drive source 21; an intermediate gear 35b engaged with the power transmission gear 35a; and a driven gear 35c attached to one end of the auger 33. The power transmission gear 35a and the intermediate gear 35b are supported by a movable arm 36 supported on the frame member 12, and are always biased in the engagement direction by biasing means (not illustrated in figures). With this structure, the engagement state between the driven gear 35c moving up and down with the rotation of the transfer unit 5 on the rotary fulcrums 50 and the intermediate gear 35b can be ensured.

With the above structure, for rotating the transfer unit 5 into a separate position, a driving force from the drive source 21 to rotate the transfer unit 5 clockwise in FIG. 9 rotates the driven gear 35c counterclockwise by the driving gear 22a and rotates the auger 33 integrally formed with the driven gear 35c in the same direction, so as to convey and recover toner which has been recovered from the belt 55 into the toner recovery container 34. In other words, the invention uses the driving force from the drive source 21 as a driving force for rotating the auger 33, so as to realize effective utilization.

Toner remaining on the belt 55 includes: toner which has adhered through a trouble in a jam in conveying a sheet or the like; toner of patch images which have been directly transferred from the image carriers 1 onto the belt 55 for the purpose of image forming process control required for maintaining the image quality; droplets of toner which has been floating in the air inside the multicolor image forming apparatus and then adhered to the belt; and the like. By removing such toner in appropriate timing as described above (at the time of changing the image formation mode), stable image quality can be ensured.

Though the embodiment conveys toner in the axial direction of the auger 33 since the auger 33 is configured as a helical member, the invention may be constructed to scrape toner out in a direction crossing the axial direction at a right angle, by attaching a blade in the axial direction. In this case, the auger 33 may be configured simply as a square member or the like.

During rotation for contact/separation of the transfer unit 5, the auger 33 is rotated in the reverse direction. This embodiment is structured to allow this reverse rotation of the auger 33 since the reverse rotation is performed infrequently and for a short time. However, in case where the reverse rotation of the auger 33 becomes a problem, the driven gear 35c may be attached to the rotary shaft 24 of the auger 33 via a one-way clutch. The reverse rotation of the auger 33 may be allowed for the sake of suppressing an increase in the cost of the image forming apparatus.

As described above, the drive source 21 of the contact/separation means 20 is used not only for moving the transfer unit 5 to and from the image carriers 1 but also for driving the auger 33 to convey the recovered toner. Accordingly, a driving force from the drive source 21 can be effectively utilized, and thereby good cost performance can be realized.

The sheet supplier 4 which is a tray used for storing a sheet to be used for image formation is provided below the image carriers 1 of the body of the image forming apparatus 100. The sheet discharge section 8a provided above the body of the image forming apparatus 100 is a tray used for laying a printed sheet face down thereon. The sheet discharge section 8b provided at a side portion of the body of the image forming apparatus 100 is a tray used for laying an image-formed sheet face up thereon.

The body of an image forming apparatus 100 is also provided with a sheet transport path 13, which is S-formed, for guiding a sheet from the sheet supplier 4 via the transfer unit 5 and the fixing unit 6 to the sheet discharge section 8a. Furthermore, a pickup roller 14, a resist roller 15, the fixing unit 6, a switching gate 7 for switching the sheet transporting direction, a transport roller 16 for transporting a sheet and the like are arranged near the sheet transport path extending from the sheet supplier 4 to the sheet discharge section 8a and the sheet discharge section 8b.

A plurality of transport rollers 16, which are small-sized rollers for helping and assisting sheet transporting, are arranged in the sheet transport path 13. A pickup roller 14 is arranged at an end portion of the sheet supplier 4 to supply a sheet from the sheet supplier 4 to the sheet transport path 3 one by one.

The switching gate 7 is provided on a side face cover 17 so as to be rotatable, and can separate a sheet in the middle of the sheet transport path 13 to discharge the sheet to the sheet discharge section 8b, when switched over from the state indicated with a continuous line to the state indicated with a dashed line in the figure. In the state indicated with the continuous line, a sheet is guided along the transport section 13 formed in a space surrounded by the fixing unit 6, the side face cover 17 and the switching gate 7, to the upper sheet discharge section 8a.

The resist roller 15 temporarily holds the sheet transported along the sheet transport path 3. The resist roller 15 then starts transporting the sheet in proper timing with rotation of the image carriers 1 so as to preferably transfer toner images formed on the surface of the image carriers 1 one upon another.

Actually, the resist roller 15 is designed to transport a sheet based on a detection signal outputted from a resist approach detecting switch, which is not illustrated in figures, to adjust an end of a toner image formed on each image carrier 1 to an end of an image formation area of the sheet.

The fixing unit 6 is provided with a heat roller 6a, a pressurization roller 6b and the like. The heat roller 6a and the pressurization roller 6b are rotated on the opposite sides of the sheet.

The temperature of the heat roller 6a is set to be a predetermined fixing temperature by a controller on the basis of a signal from a temperature detector which is not illustrated in figures. The heat roller 6a and the pressurization roller 6b apply thermo compression bonding on the sheet, to make a multicolor toner image transferred onto the sheet melted, mixed, pressure-welded and then heat-fused onto the sheet.

Note that, after the multicolor toner image fusing operation, the sheet is transported to a reversed sheet discharge path of the sheet transport path 13 by the transport rollers 16, and discharged onto the sheet discharge section 8a in a reversed manner (with the multicolor toner image facing downward).

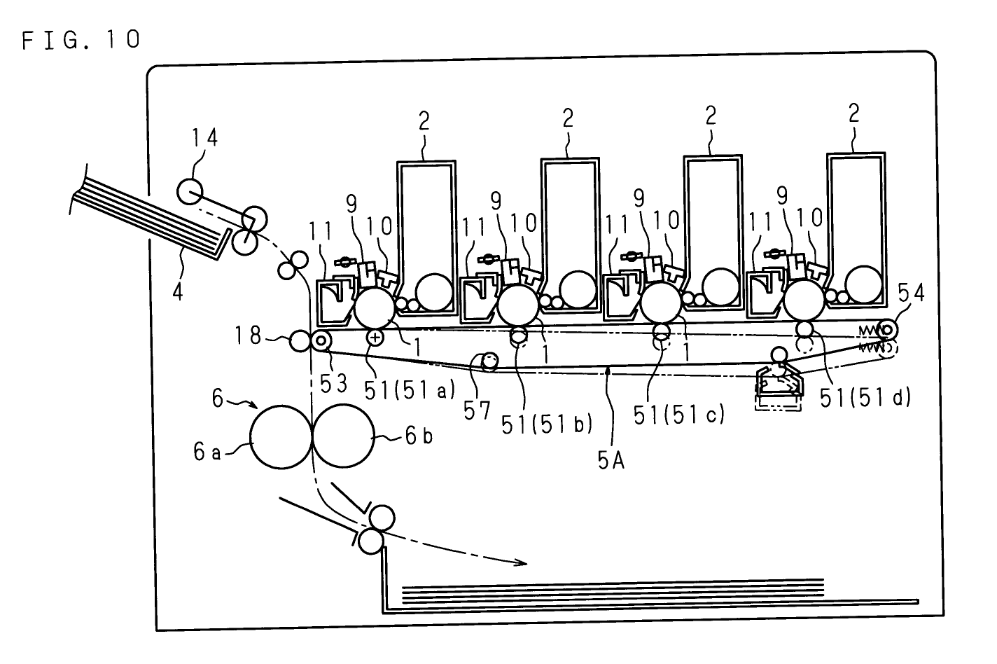

Though the above embodiment explains a multicolor image forming apparatus of direct transfer type which directly transfers an image from the image carriers 1 onto a sheet, a multicolor image forming apparatus of indirect transfer type including an intermediate transfer belt as a transfer unit 5 as illustrated in FIG. 10 may be employed. In the apparatus of indirect transfer type, the same effect can be obtained by employing the structure of the auger 33 and the contact/separation means 20 for driving the auger 33 as illustrated in FIGS. 6 through 9.

FIG. 10 is a schematic view illustrating the structure of an image forming apparatus of indirect transfer type. This image forming apparatus has an intermediate transfer belt 5A as a belt 55 of the transfer unit 5, and a roller member functioning as a secondary transfer member (secondary transfer roller) 18 as a roller member corresponding to the driving roller 53. A toner image formed on each image carrier 1 is temporarily transferred onto the intermediate transfer belt 5A, and then retransferred from the intermediate transfer belt 5A onto a transported sheet by the secondary transfer member (transfer roller) 18. Since other structures and functions are the same as those of the above embodiment, the same parts are designated with the same reference numbers in FIG. 10, and the detailed explanation and the explanation of the functions and effects are omitted.

Though the above embodiment explains a case where the rotary fulcrums 50 are provided at an upstream side end portion in the sheet transporting direction of the transfer unit 5, the rotary fulcrums 50 may be provided at a downstream side end portion in the sheet transporting direction of the transfer unit 5. Moreover, though the above embodiment explains a case where the tension roller 54 is provided on the side of the rotary fulcrums 50 and the driving roller 53 is provided on the side of the opposite rotary fulcrums 50, the driving roller 53 may be provided on the side of the rotary fulcrums 50 while the tension roller 54 may be provided on the side of the opposite rotary fulcrums 50.

The transfer unit 5 may be of ring type which is not illustrated in figures, not of the belt type having a belt, comprising a support ring corresponding to the arrangement track of a plurality of image carriers 1 arranged apart from each other along an arc-shaped sheet transport path, and transfer members (transfer rollers) corresponding to the respective image carriers 1, which transfer members are supported by the support ring. In this case, the fulcrums 50 are provided in the vicinity of an extension of the axis of a transfer member (transfer roller) on upstream side or downstream side in the sheet transporting direction so as to be approximately parallel to the axis, so that the ring member is rotated on the fulcrums 50 between a separate position, in which the ring member is separate from the image carriers 1, and a contact position.

Though the above embodiment explains a case where the rotary fulcrums 50 are constituted of shafts formed integrally with the supporter 5, the rotary fulcrums 50 may be configured, for example, as two holes into which two shaft portions projected from the frame member 12 are inserted. Furthermore, the rotary fulcrums 50 may be configured as holes into which shafts formed independently from the supporter 5 are inserted, so that the shafts inserted into the holes are inserted into and supported at support holes formed in the frame member 12.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An image forming apparatus comprising:
a plurality of image carriers arranged in a sheet transporting direction; and
a transfer unit, which has transfer members corresponding to the respective image carriers, for transferring images carried on the respective image carriers,
wherein the transfer unit has a rotary fulcrum in the vicinity of an extension of the axis of a transfer member located on one end portion in the sheet transporting direction so as to be approximately parallel to the axis, and can be rotated on the rotary fulcrum in directions of moving to and from the image carriers.

2. The image forming apparatus according to claim 1, wherein the transfer members are movable in directions of moving to and from the image carriers.

3. The image forming apparatus according to claim 1, wherein the transfer unit includes a supporter for supporting the transfer members, and the supporter has the rotary fulcrum.

4. The image forming apparatus according to claim 1, wherein the transfer unit is rotatable on the rotary fulcrum so that a distance between a first transfer member adjacent to a second transfer member closer to the rotary fulcrum and an image carrier corresponding to the first transfer member comes to between 2.5 mm and 4 mm when the transfer unit is separated from the image carriers.

5. A transfer unit comprising:
a plurality of juxtaposed transfer members; and
a supporter for supporting the transfer members so as to be rotatable and movable in a radial direction,
wherein the supporter has a rotary fulcrum in the vicinity of an extension of the axis of a transfer member located at one end portion in a direction in which the transfer members are juxtaposed, so as to be approximately parallel to the axis.
